(19) United States
(12) Patent Application Publication
(10) Pub. No.: US 2020/0346485 A1
(43) Pub. Date: Nov. 5, 2020

(54) METHOD OF CUSTOMIZING FOOTWEAR

(71) Applicant: Melissa Briner, Thornton, PA (US)

(72) Inventor: Melissa Briner, Thornton, PA (US)

(21) Appl. No.: 16/863,242

(22) Filed: Apr. 30, 2020

Related U.S. Application Data
(60) Provisional application No. 62/840,772, filed on Apr. 30, 2019.

(51) Int. Cl. B44D 2/00; A43D 999/00; A43B 3/00

(52) U.S. Cl. CPC B44D 2/00; B44D 2/007; A43B 3/0078; A43D 999/00

(57) ABSTRACT

A method of customizing dressy or formal footwear with a discreet design or logo on a specific area of a shoe, then painting the design in paint and sealing the design with varnish.

### CLAIM FOR PRIORITY

The subject non-provisional application claims priority under all applicable U.S. statutes, including 35 U.S.C. § 119(e), to U.S. Provisional Application No. 62/840,772, filed Apr. 30, 2019, titled Method of Customizing Footwear.

### FIELD OF THE INVENTION

The present invention relates generally to personalizing footwear and, more specifically, to applying designs or logos to shoes.

### BACKGROUND OF THE INVENTION

It is well-known for sneaker manufacturers and other manufacturers of casual shoes to apply their trademark or other indicia that identifies the source of the goods to their sneakers. For example, Nike's Swoosh® is one of the most well-known trademarks.

In addition, it is also known to decorate sneakers, cleats, or similar athletic shoes made from canvas by drawing directly on the canvas with a permanent marker, spray paint or paint pens. This method of decorating sneakers is made possible because of the absorbing nature of the canvas material. For example, for one game a year, the National Football League permits their players to decorate their cleats during the “My Cause, My Cleats” promotion that provides players with an opportunity to bring attention to, and raise money for, a player's preferred charity. The “My Cause, My Cleats” week is a high-profile event and sundry methods for decorating the cleats of professional football players are disclosed. However, since each player has their own preferred charity, most of the designs/decorations are unique, and efficient methods for decorating a large number of cleats for this once-a-year event have not been explored. Also, since the cleats are only used for one game, no technique for preserving the design on the cleats appears to have been developed.

Outside of such high-profile events, customization for purchasers or owners of footwear is not so well-known. Some shoe owners use decorative pins comprising a stud and a mating clasp, similar to earrings for pierced ears. The stud comprises a head that forms the decorative or ornamental design attached to a sharp, needle-like post that extends therefrom. The pin is attached to a casual shoe by pushing the pointed end of the post through the outer side of the shoe; with the post now extending into the interior of the shoe, the pin is then secured with the clasp that frictionally slides onto the pointed end. This type of customization is not ideal since it destroys the integrity of the shoe thereby reducing the strength of the material or allowing a path for water or other elements to enter the shoe.

Charms for customizing Croc® brand shoes and similar casual shoes are known. A common design of most Croc® brand shoes is that the upper part of the shoe has a plurality of ventilation holes to allow the foot to “breathe.” The top or head of the charm comprises a cartoon character, a colorful design or logo, which is attached via a short post to a button-like end. The owner of the Croc shoes tilts the charm so that a smaller surface area is presented to one of the breathing holes, and the button-like end is forcibly inserted into the hole similar to buttoning a shirt.

In U.S. Patent Publication No. 2014/0115927, a means and method for customizing boots is disclosed. The boot customization disclosed comprises a clear plastic sleeve attached to the calf-section of the boot. A sheet-like insert, having a design on at least one side, is slid between the plastic sleeve and the material of the boot. The insert may be changed out for a different insert thereby allowing the owner to customize the appearance of the boot. The sleeve is attached to the calf-section of the boot along three sides and the fourth side is closed with a zipper.

As stated above, the pin means of customization degrades the integrity of the shoe; the charms for Croc-type shoes are limited to footwear that is manufactured with a plurality of ventilation holes in the shoe's upper. The customization method for boots requires that the boots have an extra manufacturing step of adding a plastic sleeve attached to the calf-section of the boot. The comfort of a boot with an extra layer of plastic on the outside is likely impacted. These are very specific means for an owner to customize their shoes, and none are ideal. Accordingly, there is a need for a means to customize footwear that does not degrade the integrity of the shoe, is not limited to one specific style of shoe, does not impact the comfort of the shoe/boot, and can be preserved for an extended period of time.

### SUMMARY OF THE INVENTION

The present invention is method for a shoe owners and manufacturers to customize their shoes with almost any style or design. One goal of the present invention is to customize a dress shoe but retaining the appearance of formality after customization. The subject method includes prepping/cleaning the shoe, and applying a base layer of paint; next, a sketch of the desired logo or design is drawn (preferably with a pencil) on the base layer of paint. Alternatively, a template may be used to form the desired design.

Another goal of the present invention is to preserve the design for an extended period of time and, in many cases, for the life of the footwear. Preservation is achieved by applying one or more layers of lacquer over the design.

Another unique feature of the present invention is that the design may incorporate words to display a message, a warning, advertising, or a favorite saying or proverb. Accordingly, there is no limit to the types of designs that can be applied to a shoe other than the talent of the “artist” drawing the logo or design. Alternatively, a logo or design prepared on another material (similar to a patch or appliqué) may be applied to the shoe in place of painting a design, and then lacquered over.

In contrast to the known prior art, the owner is limited in customization choices by the manufacturer of the pins, charms or inserts. The boot customization has its own drawbacks including that it appears to be limited to boots (i.e., not shoes), the extra cost of the material and manufacturing step of having a clear plastic sleeve attached to the boot, and the likely impact on the boot wearer's comfort. In other words, before the present invention, the owner of a pair of shoes has minimal options for customization and what customization that is available depends on the types of pins or charms being sold.

The subject invention allows more customization by the owner of the shoes. The only limitations of the subject method are the imagination of the owner and the drawing ability of the owner or the owner's friend. (Of course, a third-party artist or graphic designer may be hired to draw the design onto the shoe.) In addition, in contrast with previous customization of cleats, the design can be considered permanent.

### BRIEF DESCRIPTION OF THE DRAWINGS

The foregoing summary, as well as the following detailed description, may be better understood when read in conjunction with the accompanying drawings, which are incorporated in and form a part of the specification. The drawings serve to explain the principles of the invention and illustrate embodiments of the present invention that are preferred at the time the application was filed. It should be understood however that the invention is not limited to the precise arrangements and instrumentalities shown.

FIG. 1 is a flowchart outlining the steps of customizing a shoe in accordance with the present invention.

FIG. 2 is a perspective view of a shoe illustrating the step in the customization of a shoe by taping off the section of shoe on which the design or logo will be applied in accordance with the present invention.

FIG. 3 is a picture of the shoe after it has been customized with an apple positioned proximate the heel of a shoe in accordance with the present invention.

FIG. 4 is a picture of the shoe after it has been customized with a section of the Maryland state flag positioned proximate the laces of a dress shoe in accordance with the present invention

### DETAILED DESCRIPTION OF THE PREFERRED EMBODIMENT

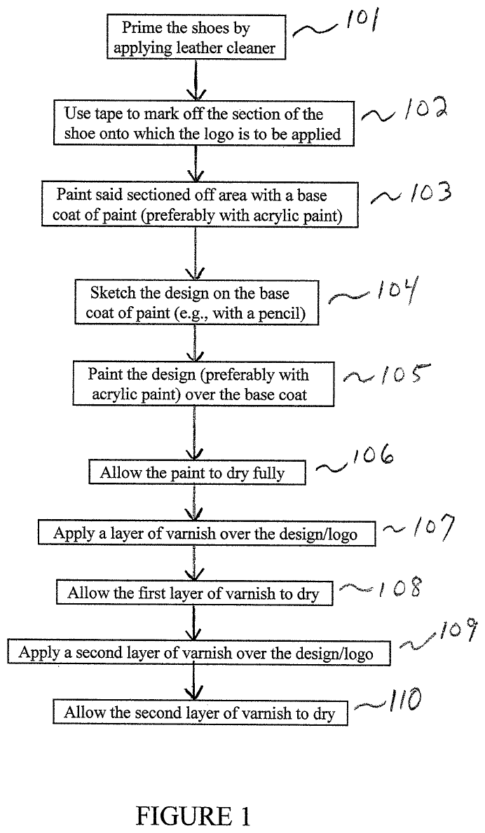

The present invention is illustrated by reference to FIGS. 1 through 4. With reference to FIG. 1, a flowchart of the preferred method of customizing a shoe in accordance with the present invention is shown. The primary steps are:
101—Step One: Prime the shoes by applying leather cleaner.
102—Step Two: Using tape (preferably painter's tape or a similar professional masking tape), outline the perimeter area of the shoe onto which the desired logo or design will be applied.
103—Step Three: Paint base coat in acrylic paint.
104—Step Four: Sketch the design in pencil on the layer of paint.

If the design is going to be applied to many pairs of shoes, it is preferable to use a template to reproduce the design exactly on each pair of shoes. Use of a template is desirable when the design is popular and there is anticipated to be high demand; for example, if the design is the logo of a professional football team (e.g., an eagle's head for the Philadelphia Eagles) or a college baseball team (e.g., a stylized red “0” for the Ohio State University).
105—Step Five: Paint in the design using acrylic paint.
106—Step Six: Allow the paint to dry fully.
107—Step Seven: Paint a layer of glossy or matte varnish depending on the design.
108—Step Eight: Allow the first layer of varnish to completely dry (preferably at least a twelve hours).
109—Step Nine: Paint a second layer of varnish over the first layer of varnish.
110—Step Ten: Allow the second layer to dry another 12 hours.

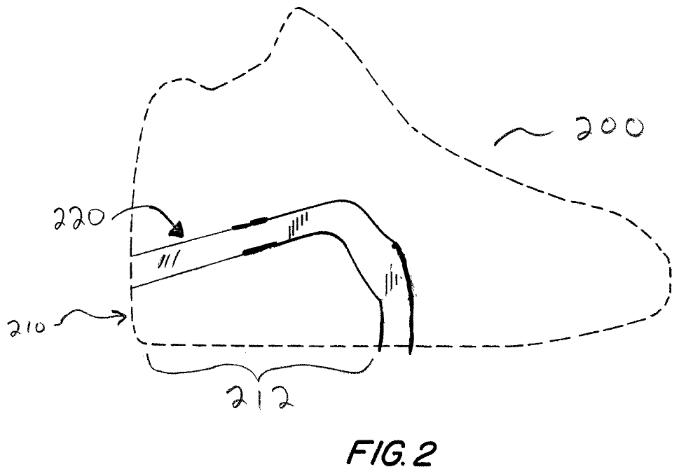

Referring now to FIG. 2, a shoe 200 is shown. In this Figure, the logo will be applied to the side area 210 of the shoe above the heel. The First Step 101 of the subject method is to apply a leather cleaner to an area 212 at least the size of the desired logo, although it may be applied to the entire shoe upper above the sole. The Second Step 102 in the method according to the preferred invention, as shown in FIG. 2, is to outline the outer edges of the maximum limits of the area 212 in painters' tape 220 or similar means. The design or logo will be placed inside the area 212 outlined by the tape 220. The tape is intended to protect the portion of the shoe which will not be customized.

The Third Step 103 in the method is to paint the area 212 where the design will be applied in a base coat of paint 224. In the preferred embodiment, the base coat is acrylic paint. The color of the base coat can complement the colors in the logo that will eventually be applied or contrast the colors in the design to bring out the colors in the design. Many professional sports teams and colleges have a specific color scheme that can be used to identify the team. For example, the Miami Dolphins professional football team uses an aqua and orange color scheme; one of these primary colors can be used for the base coat.

It should be noted that Step 103 is included since the final design is best viewed when a base coat of paint is used. A person skilled in the art would recognize that the design may be applied directly to the material of the shoe after the shoe has been prepared by cleaning the underlying area (Step 101). In other words, Step 103 may be skipped if the color of the shoes properly highlights/contrasts the design, or the desired effect is to make the design even more discreet or less obvious.

The Fourth Step 104 is to sketch the design or logo in pencil on the base coat layer of paint. The design or logo can be anything the owner wants and is not limited to a specific shape, character or cartoon. If the design or logo is intricate, it may be best to recruit a person with artistic ability to sketch the design.

Although penciling in the design is preferred, a pen, chalk or other means may be used. Moreover, in order to make a highly detailed design, or to show additional texture or layers, utilizing a knife to cut all of the design into the shoe, or only certain features, may be the preferred method of applying the design to the base coat. (It should be noted that by utilizing a knife to cut into the material of the shoe, very fine details may be reproduced by using a paint pen or similar means to color only the cut portion.)

As mentioned previously, if the design is anticipated to be popular or many pairs of shoes are to be decorated, it may be preferable to manufacture a template so that each design is identical and reproducible. Such an instance may be when an entire wedding party wishes to display the same design.

After the design has been sketched onto the base coat of paint, Step Five 105 consists of painting the design using acrylic paint.

Once the owner is satisfied with the design, Step Six 106 is to allow the paint to dry fully. The time required depends on the type of paint used to make the design. The paint manufacturer's recommended drying time should be followed.

Once the design is fully dried, Step Seven 107 is to protect the design by painting a layer of clear varnish or lacquer over the design. The choice of a glossy or a matte varnish is another design choice of the owner and what effect they are trying to evoke.

Step Eight 108 requires that the first layer of varnish dry at least twelve hours.

In the preferred embodiment, Step Nine 109 involves applying a second coat of varnish over the first coat. Finally, Step Ten 110 requires allowing the second layer of varnish to dry (preferably for at least twelve hours). Once the second layer of varnish is fully dried, the owner can wear the shoes.

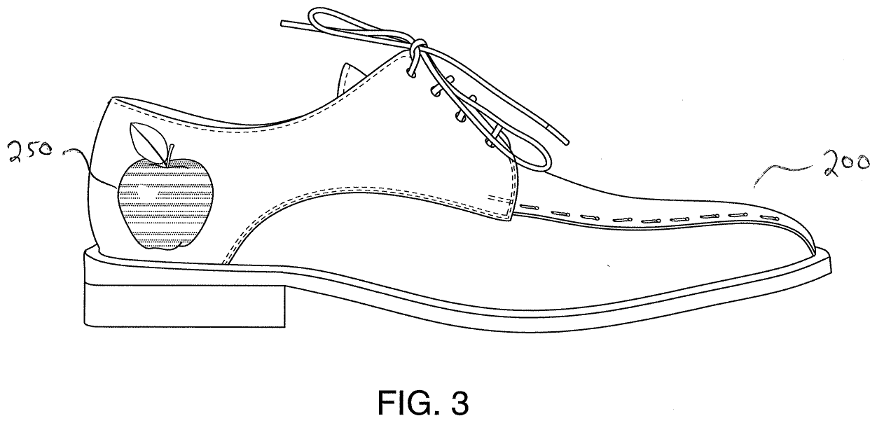

Referring to FIG. 3. the drawing shows an apple 250 design located on the shoe upper above the heel. The shoe depicted is preferably a dress shoe, and the design is not intended to be so garish that it detracts from the appropriateness or wearability of the dress shoe at formal gatherings (such as a wedding or college reunion).

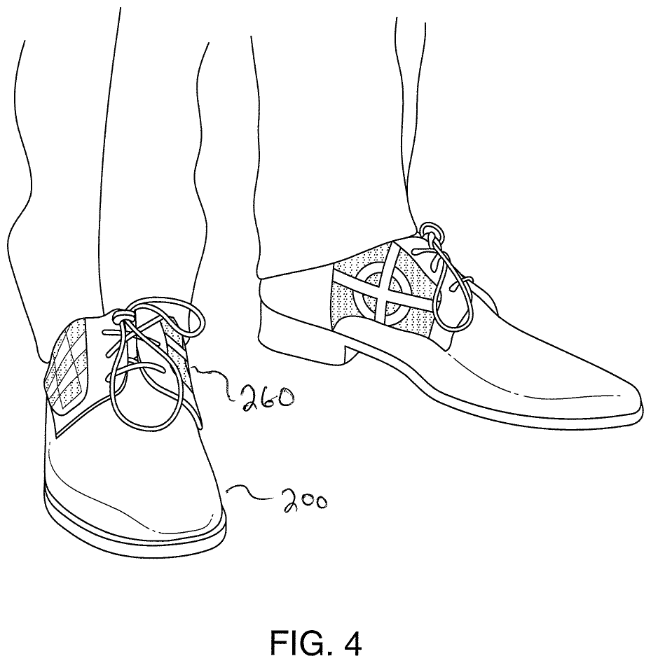

Referring now to FIG. 4, the drawing shows a partial reproduction of the Maryland state flag 260 applied to a different area of the shoe's upper closer to the laces.

As one will note from FIGS. 3 and 4, the subject method disclosed is preferably applied to leather dress shoes. The method is equally applicable to shoes and other types of footwear having area(s) comprised of material(s) to which the paint and other described application products will adhere, in addition to leather. It should be apparent to a person skilled in the art to make minor adjustments to the method when applying the design to shoes made of different materials.

Also, it should be noted that the customization does not have to be limited to a design or logo. For example, a word (e.g., a person's name) or phrases (the name of a college or university) may be applied to the shoes. Further, the design is not limited to being fanciful but can be utilitarian (i.e., by conveying a message or warning through its shape). For example, using an international warning symbol on a pair of leather work boots.

Although the primary object of the preferred embodiment is to apply a discreet but personal design to a pair of men's dress shoes without detracting from the usefulness of the shoes, it is not the intention to limit this process to men's dress shoes. The disclosed process may be similarly used to apply a design to women's dress shoes, a child's shoes, or to utilitarian shoes such as work boots.

Unlike previously known methods used to apply an attention-grabbing design to a sneaker or cleat, it is a preferred that the subject process apply a design or logo that is somewhat discreet so that the dress shoes may be worn to various formal functions without drawing unusual or undesirable attention. Also, the pair of shoes to which the design is applied are not intended for a one-off use.

Although this invention has been described and illustrated by reference to specific embodiments, it will be apparent to those skilled in the art that various changes and modifications may be made which clearly fall within the scope of this invention. The present invention is intended to be protected broadly within the spirit and scope of the appended claims.

I claim:

1. A method of customizing a shoe's surface comprising the steps of:
a) preparing said shoes by priming the surface of said shoes;
b) taping off a section of the shoes on which the customization will be located;
c) painting said taped-off section with a base coat of paint;
d) sketching a design in pencil on the layer of paint;
e) painting in the design using acrylic paint;
f) allowing the paint to dry fully;
g) applying a layer of varnish over the design to seal it; and
h) allowing said layer of varnish to dry at least twelve hours.

2. The method of claim 1 further comprising the steps of:
i) applying a second layer of varnish over the design; and
j) allowing said second layer of varnish to dry.

3. The method of claim 1 wherein said base coat is acrylic paint.

4. A method of customizing a shoe's surface comprising the steps of:
a) manufacturing a template bearing a desired design or logo;
b) preparing said shoes by priming the surface of said shoes;
c) taping off a section of the shoes on which the customization will be located;
d) painting said taped-off section with a base coat of paint;
e) using said template, outlining, by any means, a design on the layer of paint;
f) painting in the design using contrasting paint;
g) allowing the paint to dry fully;
h) applying a layer of varnish over the design to seal it; and
i) allowing said layer of varnish to dry at least twelve hours.
